(19) United States
(12) Patent Application Publication
(10) Pub. No.: US 2009/0015018 A1
(43) Pub. Date: Jan. 15, 2009

(54) Flow Stream Momentum Conversion Device Power Rotor

(76) Inventor: Jasper M. Nail, Picayune, MS (US)

Correspondence Address: BUTLER, SNOW, O'MARA, STEVENS & CANNADA PLLC, 6075 POPLAR AVENUE, SUITE 500, MEMPHIS, TN, 38119, US

(21) Appl. No.: 12/164,874

(22) Filed: Jun. 30, 2008

Related U.S. Application Data
(60) Provisional application No. 60/958,686, filed on Jul. 9, 2007.

(51) Int. Cl. F03D 9/00

(52) U.S. Cl. 290/55

(57) ABSTRACT

A device known as a Flow Stream Momentum Conversion Device (FSMCD) Power Rotor has been invented. The device makes use of the principle of Conservation of Momentum to convert fluid stream input momentum to device rotational power. A unique and non-obvious aspect of the fluid momentum conversion is circumferential discharge. This aspect maximizes power conversion in a given cross section of open stream flow. Power is extracted from the device as mechanical loading is applied to the rotating shaft resulting in a decrease in rotational speed and an increase is shaft torque. The device has practical usage in both wind and water flows. Under the condition of zero rotor shaft loading the device may be configured to make linear stream measurement of flow speed. This invention has applications in utilizing both unidirectional and bidirectional “fluid stream” flow. It is especially effective in tidal and wave action applications.

### CROSS REFERENCE TO RELATED PATENT APPLICATION

This application claims the benefit of U.S. Ser. No. 60/958,686 Filed Jul. 9, 2007 under 35 U.S.C. § 119(e) (hereby specifically incorporated by reference in its entirety).

### FIELD OF THE INVENTION

The present invention relates to power extraction from slow to moderately fast moving fluid streams. In particular, it relates to rotary devices such as windmills, turbines, and propellers that convert moving wind or water stream energy into useable shaft power.

### BACKGROUND OF THE INVENTION

Both wind and water streams have for centuries produced useable shaft power through the conversion of kinetic energy of stream flow to rotary motion. These sources of energy continue to be desirable choices since they are renewable and they are environmentally friendly. High-speed fluid flows provide most of the usage. There are significant advantages in power conversion of high-speed stream flow as compared to lower flow rates. These advantages stem from requiring smaller cross section of flow, less gearing, and smaller parts to achieve the same power extraction as compared to slower flow rates. Although these fast moving flows have practical usage advantages there are significant disadvantages in their use. One such disadvantage is the relatively small number of naturally occurring sites of fast moving wind and water. There are not many places to find 15 to 60 knot prevailing wind speed, or “Niagara Falls” type natural water pressure “heads.” To supply manmade sites for such large pressure heads generally requires construction of large reservoirs. The cost of such major construction is enormous and contributes unfavorable environmental factors. A second disadvantage is the general complexity of construction of the devices due to rotor dynamics tending toward greater vibrations and imbalance, and the necessity for speed control.

In contrast, there are numerous sites for relatively slow to moderate wind speeds and water flow. In the water applications, the slow to moderate flow rates are found not only in many rivers, but also in tidal flows and ocean waves. Wind applications for low to moderate flow streams are numerous, as well. Prior art turbines similar to those used in high-speed flow have been developed in attempts to extract meaningful power from unidirectional low-speed flow. Turbine rotor utilization at these lower flow rates present more of a technological challenge. Various methods have been implemented to overcome these challenges. Most of these involve speed up of flow devices. Thompson, U.S. Pat. No. 4,224,527—(9/1980) advanced the Fluid Flow Intensifier which dealt with horizontal flow both unidirectional and bidirectional, but not wave action. Weyers introduced the Wave Powered Motor, U.S. Pat. No. 4,327,296—(4/1982) which dealt with bidirectional ocean wave flow. Monk, et al, U.S. Pat. No. 4,289,444—(9/1981) and McDavid, Jr., U.S. Pat. No. 6,800,955 B2—(10/2004) used horizontal flow to create vortex flow to rotate turbines. All of the cited examples are complex and require additional vanes, baffles, turbines, and controls to achieve the fluid-streams to rotational energy conversions. Bidirectional flows are the most numerous in naturally occurring water sites, but provide the most challenge using the conventional prior art systems.

The approach taken by the present invention for solving the energy extraction from slow to moderate moving stream flow was to develop a rotary device that converts nearly all of the energy available in the stream flow cross section to rotational energy as simply and as efficiently as possible. Subsequent to the highly efficient energy conversion, the mechanical rotor power may then be used for direct conversion to electrical energy. The present invention offers unique and useful advantages over the conventional prior art devices. Also, the present invention relates to the special case of minimum shaft loading. In this case, the present invention has application as a unique linear stream flow-speed measuring device.

One characterization of the total available energy in stream flow is stream momentum. The present invention relies on conversion of this momentum to provide for meaningful rotary power extraction from slow to moderately fast wind and water unidirectional flow. The device uses a single rotor with no supporting pipes, baffles, controls, etc. A configuration of the device for bidirectional fluid flow through the device is shown to be novel and extremely useful in providing a means to directly convert bidirectional flow energy to rotational energy with one moving rotary device. Also a linear flow speed measuring rotor configuration of the device is introduced.

### SUMMARY OF THE INVENTION

This invention makes use of the principle of Conservation of Momentum to convert fluid stream input momentum to device rotational power. The device receives the fluid flow in the axial direction, and reduces the momentum of the fluid in the axial direction to zero by forcing the fluid outward along blade surfaces. The fluid reacting with the blade areas creates torque and rotational motion to the device's shaft. Lastly, the fluid is discharged tangent to the device's outer circumference. Power is extracted from the device as mechanical loading is applied to the rotating shaft resulting in a decrease in rotational speed and an increase is shaft torque. The device has practical usage in both wind and water flows. It has applications in utilizing both unidirectional and bidirectional “fluid stream” open flow, and may be adapted to certain closed flow applications, as well.

The geometrical considerations maximize inlet stream area and concentrate the exiting fluid at the outer circumference area of the working volume. The fluid exits the working volume into the original stream flow but orthogonal to the flow so that there is no detrimental reaction with the original flow at discharge. The design also optimizes the blade curvature and height. This maximizes the shaft power realized from the inlet fluid flow stream.

Under the condition of zero rotor shaft loading the device may be configured to make linear stream measurement of flow speed.

This invention has demonstrated momentum conversion in both wind and water applications. It is especially effective in extracting power from bidirectional stream flow. In this embodiment of the invention, the bidirectional flow configuration consisting of back-to-back configurations of the unidirectional flow configuration assure the shaft turns in the same direction and power is extracted regardless of the axial direction of stream flow. This particular configuration will extract hydropower from tidal flows or wave actions.

### DESCRIPTIONS OF DRAWING VIEWS

FIG. 1A depicts a plan view of the configuration for unidirectional flow in a preferred embodiment of application of the Flow Stream Momentum Conversion Device (FSMCD) Power Rotor viewed from the direction at which the fluid approaches the device.

FIG. 1B depicts a plan view of the side of the FSMCD in a preferred embodiment of a configuration for unidirectional flow.

FIG. 2 depicts the configuration for bidirectional flow in a preferred embodiment of application of the FSMCD Power Rotor. The view is a plan view of a single stage bidirectional FSMCD viewed from the side.

FIG. 3 depicts a preferred embodiment of a radial flow deflector for use with the FSMCD. The view is from the side shown with the deflector attached to the barrier plate, but with blades removed, for clarity.

FIG. 4 depicts a perspective view of a preferred embodiment of a bidirectional FSMCD.

### DETAILED DESCRIPTION OF THE INVENTION

The utility, uniqueness, and non-obvious aspects in the construction and applications of the Flow Stream Momentum Conversion Device (FSMCD) Power Rotor will now be described, while referring to the drawings referenced.

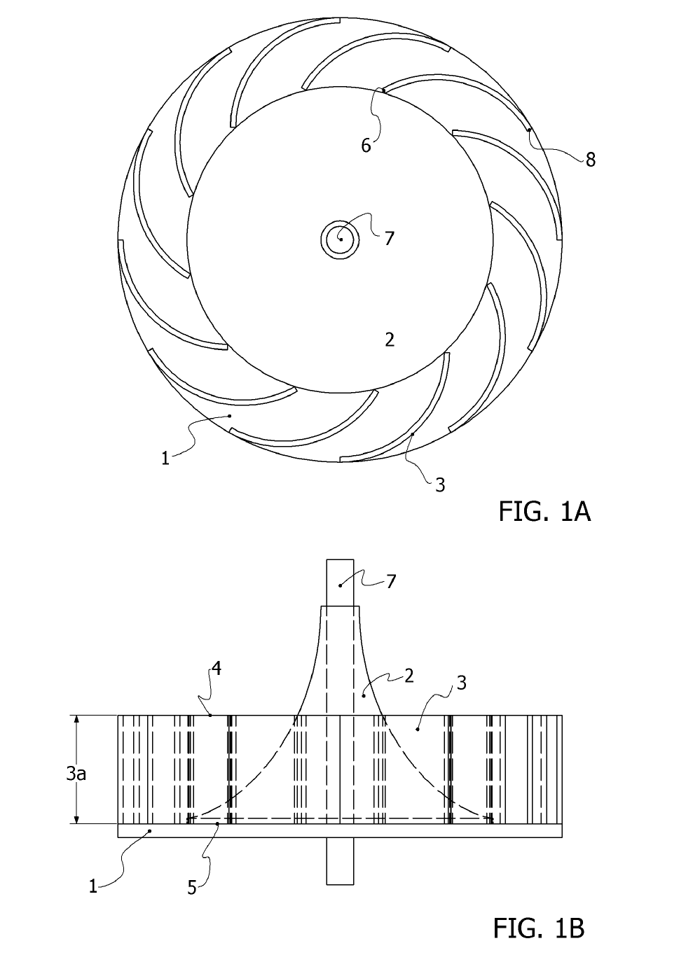

Referring to the plan view of the upstream end of a unidirectional FSMCD depicted in FIG. 1A, flow of fluid in (axially) and out (circumferentially) will cause the device to rotate in the counter clockwise (CCW) direction. The curved blades 3 configured as shown are, arbitrarily, configured with Left Handed orientation. The device may also be equipped with Right Handed blade orientation, which results in clockwise (CW) rotation of the device.

This embodiment of the invention incorporates a barrier plate 1 that is circular in shape, lying in a plane orthogonal to the inlet stream flow, attached to a shaft 7. The barrier plate 1 defines the axially directed cross sectional area of the device. This embodiment may or may not contain a radial fluid deflector 2. The purpose of the barrier plate and any radial deflector attached to or made an integral part of the plate 1 through casting is to convert axial flow into the device represented by the fluid axial momentum to radial flow momentum in a conserved manner. Sets of blades 3 are configured symmetrically around the barrier plate 1. The top edges 4 of the blades 3 face the incoming stream flow and lie within the fluid volume. The bottom edges 5 of the blades 3 intersect the barrier plate 1 plane and are attached to or cast with to form an integral part of the plate 1 at right angles to the barrier plate 1 plane. The inside edges 6 of the blades 3 lie to the inside radius of the device fluid volume. The blades 3 are shaped in the form of a curve with either a left hand or a right hand orientation. The blade outer edges 8 are located at the outside radius edge of the barrier plate 1 and the fluid volume. In this embodiment, the blades 3 are in the form of an arc from a point on the outer edge 8 of the device which is essentially tangent to the outer circumference to a location represented by the inside edge 6. Referring to the side view presented in FIG. 1B, the height 3a of the blades may vary at any radial distance. When the height 3a is mentioned, herein, it is intended to mean the axially measured perpendicular distance from top edge 4 to bottom edge 5 of the blades 3. The number, curvature, height, and thickness of the blades 3 describe a preferred embodiment that insures the axial flow into the cylindrically shaped fluid volume will flow unrestricted through the device and will discharge circumferentially along the outer blades surfaces and orthogonal to the original stream flow. One having ordinary skill in the art would recognize that the number, curvature, height, and thickness of the blades 3 may be altered without making the device ineffective.

As the fluid flow contacts the blades 3, the blades 3 apply a force resulting in a change of fluid momentum. A torque develops that turns the FSMCD. As a shaft-loading counter torque is applied to the shaft 7, power is extracted from the fluid. The geometry concentrates the exiting fluid at the outer circumference of the fluid volume and maximizes the amount of shaft power realized from a given cross section of the inlet flow stream.

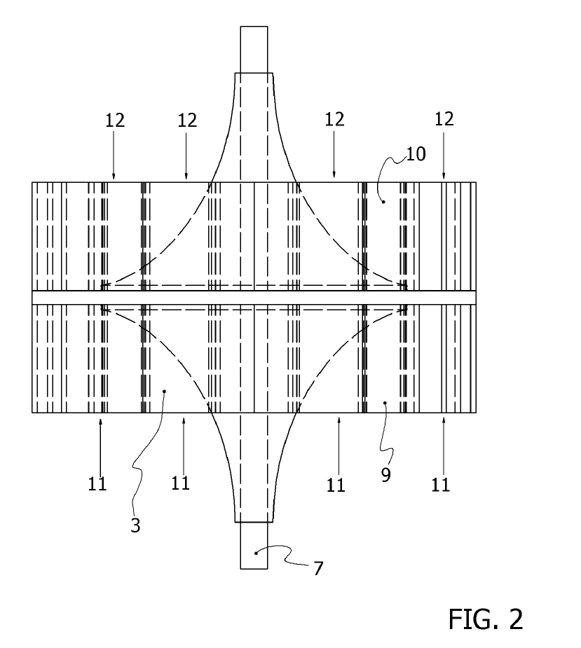

FIG. 2 shows a side view of another embodiment of the power device applied in a single stage bidirectional flow application. Both a Right Hand blade configuration 9 and a Left Hand blade configuration 10 of the FSMCD are shown in FIG. 2 configured back-to-back with a barrier plate 1 used to separate the two. This configuration will receive flow 11 into the Right Hand blade configuration shown at the bottom of the side view of FIG. 2, and will receive flow 12 into the Left Hand blade configuration shown at the top of the side view depicted in FIG. 2. These separate flows will act through the bidirectional flow device such that each will react with the blades 3 developing shaft torques to turn the shaft 7 in the same rotational direction resulting in power extraction from the bidirectional flow. While this embodiment of a bidirectional flow application involves two unidirectional FSMCD devices attached back-to-back with a common barrier plate 1, one having ordinary skill in the art would understand that a bidirectional device would only require two oppositely-oriented unidirectional FSMCDs on a common shaft 7 which may or may not share a barrier plate 1 and which may be spaced apart along the shaft 7.

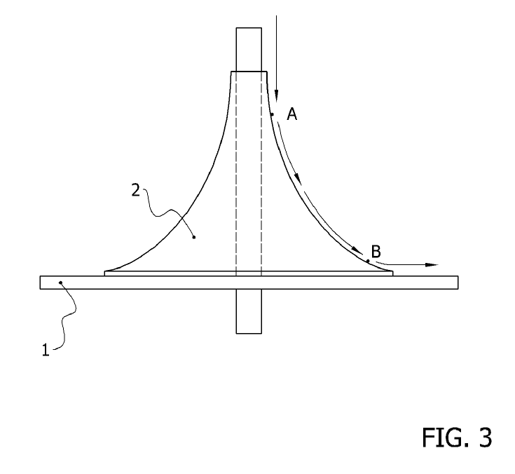

FIG. 3. Shows a side view of a preferred embodiment of a deflector 2 attached to barrier plate 1 with rotor blades 3 omitted for clarity. The deflector 2 may be used in either the left hand blade orientation or the right hand blade orientation of the FSMCD. The surface of the deflector 2 is generated by revolving a portion of a two-dimensional cycloid about the axis of rotation. In manufacture the surface can be machined, formed, or cast in a mold. The uniqueness of this surface is that it conforms to the Brachistochrone criteria. This means that flow striking the surface at any point A at some radius from the center as shown in the drawing will reach the outer radius B faster than that permitted by any other surface. Although the present invention relates to fluid flow, it is similar to the problem originally posed by Johann Bernoulli and solved by Newton in 1696 who solved the problem of the surface resulting in the fastest travel between two points for a particle moving along a surface influenced by a gravitational field of force. In the present invention the field force is represented by the water momentum of flow rather than gravity and the particles are water molecules.

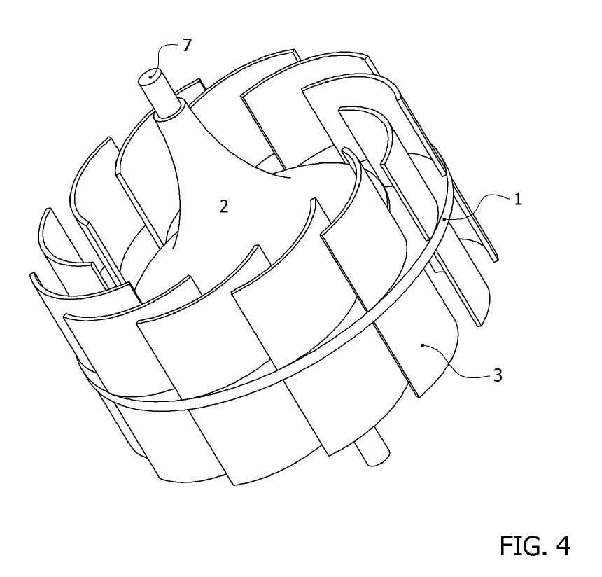

FIG. 4 shows a perspective view of a preferred embodiment of a bi directional FSMCD. All major components are clearly shown in this complete assembly depiction.

### Examples of FSMCD Unidirectional Flow Applications:

This embodiment will find application in low to moderate wind flows, in river streams, in a system incorporating the release of pressurized gas through the FSMCD, and in systems utilizing closed-system water pressure differential that induces flow through a FSMCD. Power conversion applications of the unidirectional flow configuration of the FSMCD are realized by attaching a suitable electrical converter (generator) to the device's shaft 7. The generator output supplies power to an electrical transmission line, charges batteries, or is used for electrolysis of water.

A non-obvious feature of the FSMCD unidirectional flow occurs when the shaft has near-zero shaft loading. This relation is established since there are no dissipative forces, and the mass flow rate in and out remains constant (the same cross section of flow in and out of the device). Therefore, the fluid momentum into the device, axially, must equal the fluid momentum out, circumferentially. Under these conditions the fluid speed out circumferentially equals the device tangential speed of rotation. This feature allows the FSMCD to be applied as a low to moderate stream speed flow device. This aspect of the device has been tested and verified in air and water to speeds less than 2 feet per second to yield agreement between flow speed in to device circumferential speed within 97% accuracy without corrections. There are few existing reliable methods to measure open stream low speed flow rates. The uniqueness and usefulness of application of the FSMCD in this case is that the rotational speed is easily measured, and is linearly proportional to the flow stream speed independent of fluid density. Most methods used to date require a force-to-speed non-linear correlation, or knowledge of the stream characteristics. See, e.g., Boulanger, U.S. Pat. No. 5,728,950—(3/1998) and Shoemaker, et al, U.S. Pat. No. 7,117,735—(10/2006).

### Examples of FSMCD Bidirectional Flow Applications:

For stream tidal flow, the bidirectional device depicted in FIG. 2 will be deployed beneath the surface and oriented to receive flow from incoming or outgoing tidal flow. A preferred embodiment of the tidal application will include radial deflectors as depicted in FIG. 3. Since the shaft rotation will be in the same direction, regardless of the direction of flow, there will be no need to provide for a change in direction of device orientation with a change in flow direction, thus simplifying the installation and maintenance. The shaft may be coupled to a mechanical to electrical power converter whose output may be fed to an electrical transmission line or to a bank of batteries.

For small wave action and tidal flow near the shore, the bidirectional FSMCD will be placed near the surface at low tide level. Reciprocating horizontal wave action and/or tidal flow may be received and power extracted from the flow taking advantage of both types of flow with one installation.

Open stream power may be extracted from larger wave action in deeper ocean water in several ways:
1) One method is to deploy the bidirectional FSMCD in horizontal and/or vertical orientations to a relatively fixed large flotation or platform structure. This deployment will permit direct wave action flow into the device. In doing so, reciprocating wave action flowing through the bidirectional FSMCD in the horizontal or vertical directions will provide the means to extract power from these flows.
2) Attach a bidirectional FSMCD to a small flotation (buoy) with the device fluid action areas far enough beneath the surface that the device will reciprocally move, with reference to its surroundings, with movement of the surface waves. Derived electrical power from this application will be used to charge batteries to power the electronics of weather or other types of data buoys. Several bidirectional FSMCD stages may be applied to the same shaft, with sufficient separation between stages, to increase power output at a single location.
3) Combine one large diameter bidirectional FSMCD in the manner described in 2) with smaller bidirectional devices as described in 1).

Wind flows may also be used with the bidirectional FSMCD. This embodiment may be realized by directing the wind into each end of a bidirectional FSMCD. This application will realize the benefit of minimizing axial shaft loading.

What is claimed:

1. A flow stream momentum conversion device for receiving fluid flow in an axial direction having an axial momentum, converting the fluid flow axial momentum into a radial fluid momentum, and then converting the radial fluid momentum into a circumferential momentum before discharging the fluid along and tangent to an outer circumference comprising:
a. a circular barrier plate oriented orthogonal to the axial direction, and attached to a rotor shaft defining an axis of rotation; and
b. a plurality of curved blades on at least one side of the barrier plate placed symmetrically about the axis of rotation.

2. The flow stream momentum conversion device of claim 1 further comprising:
c. at least one deflector whose surface is described by a partial cycloid of revolution about the rotor shaft provided on at least one side of the circular barrier plate.

3. The flow stream momentum conversion device of claim 1 wherein the plurality of curved blades are rigidly attached to the circular barrier plate.

4. The flow stream momentum conversion device of claim 1 wherein the plurality of curved blades are an integral part of the circular barrier plate.

5. The flow stream momentum conversion device of claim 2 wherein said flow stream momentum conversion device has exactly one deflector and wherein the plurality of curved blades are on the same side of the circular barrier plate as the deflector.

6. The flow stream momentum conversion device of claim 2 wherein said flow stream momentum conversion device has exactly two deflectors on opposing sides of the circular barrier plate and wherein the plurality of curved blades exist on both sides of the circular barrier plate.

7. A bidirectional flow application comprising at least two flow stream momentum conversion devices of claim 1 wherein the flow stream momentum conversion devices share the same rotor shaft and at least two of the flow stream momentum conversion devices are oriented to receive fluid flow in opposite directions.

8. A method for extracting power from unidirectional wind flow comprising:
a. providing the flow stream momentum conversion device of claim 1 in a unidirectional wind flow attached to a device capable of converting shaft rotation into power; and
b. extracting power from the unidirectional wind flow by allowing the unidirectional wind flow to act on the flow stream momentum conversion device of claim 1.

9. A method for extracting power from unidirectional water flow comprising:
a. providing the flow stream momentum conversion device of claim 1 in a unidirectional water flow attached to a device capable of converting shaft rotation into power; and
b. extracting power from the unidirectional water flow by allowing the unidirectional water flow to act on the flow stream momentum conversion device of claim 1.

10. A method for extracting power from bidirectional wind flow comprising:
a. providing the flow stream momentum conversion device of claim 1 in a bidirectional wind flow attached to a device capable of converting shaft rotation into power; and
b. extracting power from the bidirectional wind flow by allowing the bidirectional wind flow to act on the flow stream momentum conversion device of claim 1.

11. A method for extracting power from bidirectional water flow comprising:
a. providing the flow stream momentum conversion device of claim 1 in a bidirectional water flow attached to a device capable of converting shaft rotation into power; and
b. extracting power from the bidirectional water flow by allowing the bidirectional water flow to act on the flow stream momentum conversion device of claim 1.

12. A method for measuring flow speed of a fluid comprising:
a. providing the flow stream momentum conversion device of claim 1 attached to a device capable of measuring shaft rotation;
b. allowing the fluid to interact with the flow stream momentum conversion device of claim 1; and
c. measuring flow speed by measuring the speed of rotation of the shaft of the flow stream momentum conversion device of claim 1.
